(19) United States
(12) Patent Application Publication
(10) Pub. No.: US 2019/0251480 A1
(43) Pub. Date: Aug. 15, 2019

(54) METHOD AND SYSTEM FOR LEARNING OF CLASSIFIER-INDEPENDENT NODE REPRESENTATIONS WHICH CARRY CLASS LABEL INFORMATION

(71) Applicant: NEC Laboratories Europe GmbH, Heidelberg (DE)

(72) Inventors: Alberto GARCIA DURAN, Heidelberg (DE); Mathias Niepert, Heidelberg (DE)

(21) Appl. No.: 16/111,259

(22) Filed: Aug. 24, 2018

Related U.S. Application Data
(60) Provisional application No. 62/628,310, filed on Feb. 9, 2018.

(51) Int. Cl. G06N 99/00; G06F 17/30

(52) U.S. Cl. CPC G06N 99/005; G06F 17/30958

(57) ABSTRACT

A method is used to learn classifier-agnostic node representations that are independent from particular classification functions and carry class label information. The method includes learning representations of nodes of a graph structure according to an unsupervised learning framework by applying a distance-based or similarity-based loss between the nodes. Embeddings of the class label information are learned for at least some of the nodes. The learned embeddings of the class label information are injected into the node representations learned according to the unsupervised learning framework.

### CROSS-REFERENCE TO PRIOR APPLICATION

Priority is claimed to U.S. Provisional Application No. 62/628,310 filed on Feb. 9, 2018, the entire contents of which is hereby incorporated by reference herein.

### FIELD

The present invention relates to a method and system for learning classifier-independent node representations which carry class label information, in particular, within unsupervised learning frameworks.

### BACKGROUND

There are semi-supervised learning frameworks which can be used for learning representations. While it is an advantage that labeled data can be used in such semi-supervised learning frameworks, the frameworks are each tailored to a specific classification function. Because of this, other classification functions cannot be used within the frameworks without retraining. Also, classification functions which are not differentiable are not useable in the semi-supervised learning frameworks. In this regard, it is notable that different studies have shown that there is not one classification method outperforming all others (see King, R. D. et al., “Statlog: comparison of classification algorithms on large real-world problems,” Applied Artificial Intelligence an International Journal, 9(3), pp. 289-333 (1995); Caruana, R., et al., “An empirical comparison of supervised learning algorithms,” In Proceedings of the 23rd international conference on machine learning, ACM, pp. 161-168 (June 2006); and Caruana, R., et al., “An empirical evaluation of supervised learning in high dimensions,” In Proceedings of the 25th international conference on machine learning, pp. 96-103 (July 2008)).

There are also a number of unsupervised learning frameworks which can be used for learning representations. Examples of unsupervised learning frameworks which use a distance-based loss function between nodes include: (i) embedding propagation (EP) (see Garcia-Duran, A., et al., “Learning Graph Representations with Embedding Propagation,” arXiv preprint arXiv:1710.03059 (2017)); (ii) DEEPWALK (see Perozzi, B., et al., “Deepwalk: Online learning of social representations,” In Proceedings of the 20th ACM SIGKDD international conference on knowledge discovery and data mining, pp. 701-710 (August 2014)); NODE2VEC (see Grover, A., et al., “node2vec: Scalable feature learning for networks,” In Proceedings of the 22nd ACM SIGKDD international conference on knowledge discovery and data mining, ACM, pp. 855-864 (August 2016)); LINE (see Tang, J., et al., “Line: Large-scale information network embedding,” In Proceedings of the 24th International Conference on World Wide Web, International World Wide Web Conferences Steering Committee, pp. 1067-1077 (May 2015)); GRAPHSAGE (see Hamilton, W., et al., “Inductive representation learning on large graphs,” In Advances in Neural Information Processing Systems, pp. 1025-1035 (2017)); each of the foregoing publications being hereby incorporated by reference herein. While the learned representations in such unsupervised learning frameworks can be used with any classification model, they do not carry class label information.

### SUMMARY

In an embodiment, the present invention provides a method for learning classifier-agnostic node representations that are independent from particular classification functions and carry class label information. The method includes learning representations of nodes of a graph structure according to an unsupervised learning framework by applying a distance-based or similarity-based loss between the nodes. Embeddings of the class label information are learned for at least some of the nodes. The learned embeddings of the class label information are injected into the node representations learned according to the unsupervised learning framework.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1A schematically illustrates the pipeline of a graph-based semi-supervised learning approach;

FIG. 1B schematically illustrates the pipeline of a graph-based unsupervised learning approach;

FIG. 1C schematically illustrates learning representations that carry class label representation while being able to choose the most accurate classification function available in a given production system according to an embodiment of the present invention;

FIG. 2 illustrates steps of an Algorithm 1 for learning classifier-agnostic representations according to an embodiment of the present invention;

FIG. 3 schematically illustrates a small part of a citation network with three label types;

FIG. 4 schematically illustrates random-walk based node embedding methods;

FIG. 5 schematically illustrates how EP passes messages between nodes and computes a loss;

FIG. 6A shows a visualization of the embeddings of 700 sampled nodes (100 per class label) of the Cora citation network wherein two-dimensional vectors were generated by applying t-sne to 128-dimensional embeddings generated by EP; and

FIG. 6B shows a visualization of the embeddings of 700 sampled nodes (100 per class label) of the Cora citation network wherein two-dimensional vectors were generated by applying t-sne to 128-dimensional embeddings generated by S-EP, and

FIG. 7 schematically illustrates a personalization method and system incorporating classifier-agnostic representation learning according to an embodiment of the present invention.

### DETAILED DESCRIPTION

Embodiments of the present invention provide for learning of “classifier-agnostic representations,” which are representations that are both 1) independent from a particular classification function (i.e., they are classifier-independent representations); and 2) carry class label information. In particular, the representations are vector representations that are learned to carry the label information, but without a supervised loss such that the representations are independent of a particular classification function. Such classifier-agnostic representations have several advantages. For example, since they are independent of specific classification functions, it is possible to choose the most accurate classification function available depending on the application or production system. Moreover, the classification function does not have to be differentiable since it is not used during the representation learning phase. This also means that the entire end-to-end system does not have to be retrained when a new classification function is to be tested and deployed.

The technique according to embodiments of the present invention includes to learn embeddings not only for the nodes of the graph, but also for their class labels if they exist. The embedding of class label labels is at the same time learned and injected into the node embeddings of the underlying graph. This technique is not limited to one single unsupervised learning framework, but rather is applicable to all unsupervised approaches that use a distance-based loss function between node representations.

The inventors have recognized that that classifier-dependent embeddings in conjunction with classifiers other than those used in the supervised loss result in performance deteriorations. Furthermore, experiments demonstrate that the classifier-agnostic representation learning approach according to embodiments of the present invention is competitive with and often outperforms state of the art representation learning methods. Embodiments of the present invention have also been evaluated and compared to existing unsupervised and semi-supervised methods on data sets where an affinity graph has to be constructed first. As a result, it has also been shown that inducing class label information into classifier-independent representations is also beneficial in this setting. An additional advantage according to a particular embodiment of the present invention is an extension of the graph-based learning framework to incorporate sequence data such as sequences of feature vectors computed from audio data.

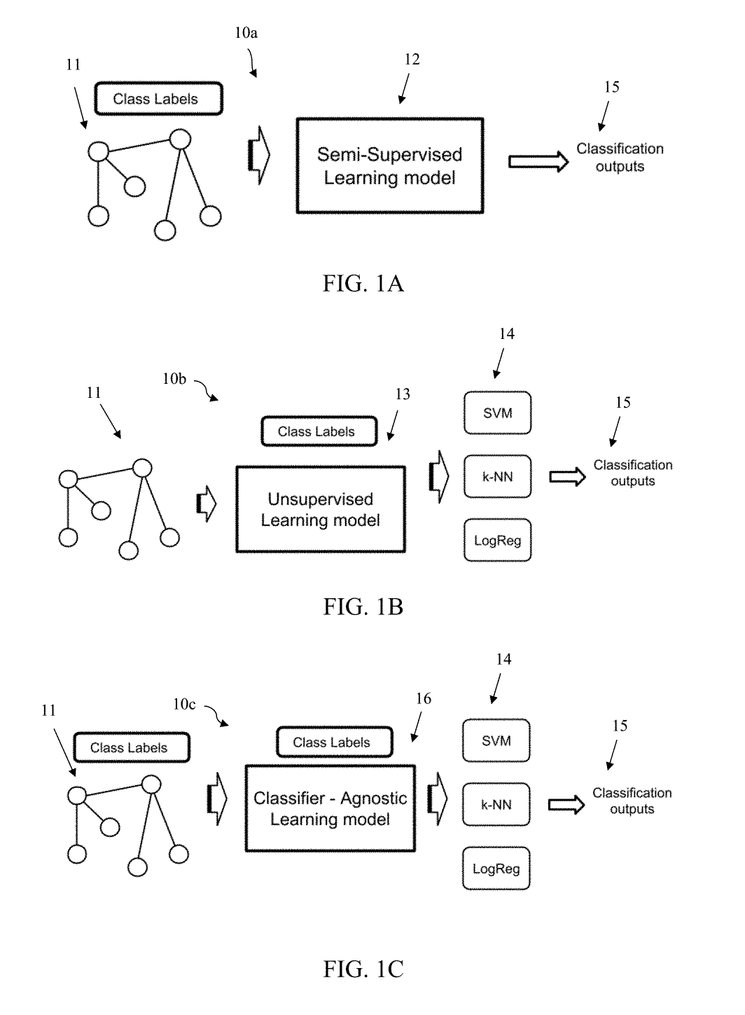

FIG. 1A illustrates the working of a graph-based semi-supervised learning framework 12 in a semi-supervised system 10a, FIG. 1B illustrates the working of a graph-based unsupervised learning framework 13 in an unsupervised system 10b and FIG. 1C illustrates the working of embodiments of the present invention in a system 10c for node classification problems. For each of the systems 10a-10c, a graph 11 is either given by the particular training data set or is induced, for example, as discussed below. Unlike in FIGS. 1B and 1C where different classification functions 14 (such as support vector machines (SVM) algorithms, k-nearest neighbors (k-NN) algorithms or logistic regression (LogReg or LR) algorithms) can be applied to the learned model, the learned model according to FIG. 1A is specifically tailored to a particular classification function 14 used for the supervised loss during the learning. In contrast to the unsupervised learning model 12 according to FIG. 1B, embodiments of the present invention schematically illustrated in FIG. 1C provide for learning representations as in a classifier-agnostic learning model 16 that carry class label information. Accordingly, embodiments of the present invention combine the advantages of being able to learn class label information without a supervised loss, and the ability to apply any of the classification models 14 to the learned node representations. After each learning iteration, class labels assignment can be performed as the output 15 of the classification function. In FIG. 1A, the classification function is integrated in the semi-supervised learning model, whereas in FIGS. 1B and 1C the classification function is independent from the learning model.

A graph G=(V, E) consists of a set of vertices V and a set of edges E. The semi-supervised graph-based learning approach according to embodiments of the present invention for learning the classifier-agnostic representations is in contrast to other semi-supervised learning approaches which learn embeddings with a supervised loss and is applicable to graph-based unsupervised learning frameworks that incorporate directed and undirected edges as well as various different edge types. For every data set, a graph structure is either given or can be induced based on distance or a similarity measure among the data points. The graph G can be associated with k label types L₁, . . . , Lₙ where each Lᵢ is a set of labels (values) corresponding to label type i. Besides these label types, class labels L^{C} are a kind of label type that is only available for some nodes of the graph. L(v) and L^{C}(v) are written as functions for the set of labels associated with the node v.

Without loss of generality, it is assumed, according to an embodiment, that an Unsupervised Learner (UL) that falls into the previous description (learning is done by applying a distance- or similarity-based loss between node representations by exchanging messages iteratively) is provided.

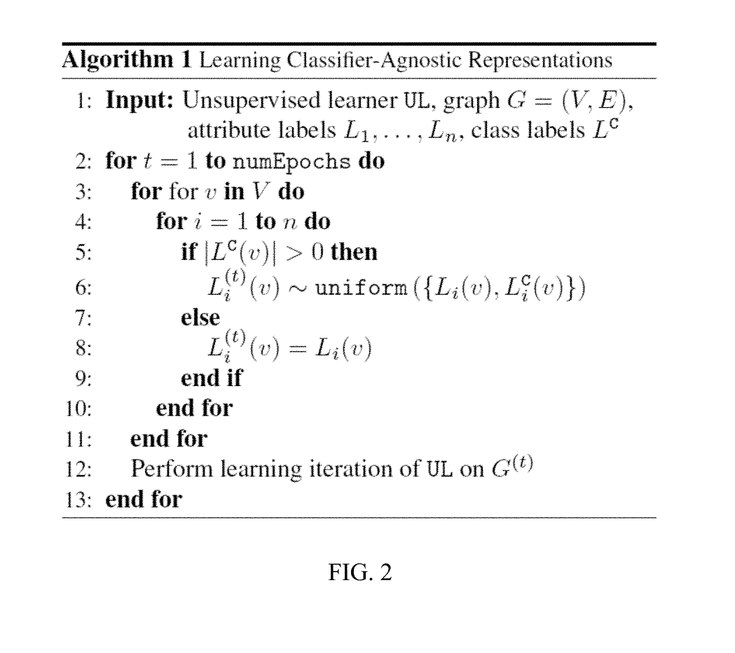

As illustrated by Algorithm 1 set forth in FIG. 2, to induce class label information into the representations learned by UL, one copy of the class labels Lᵢ^{C} are maintained for each of the attribute label types iΣ{1, . . . , n}. For each of these copies, a distinct embedding specific to the respective label types is learned. Prior to each learning iteration, an embodiment of the present invention samples for each vertex v (also referred to herein as the nodes), and each label type i, Lᵢ^{(t)}(v) uniformly at random from {Lᵢ(v), Lᵢ^{C}(v)}. Lᵢ^{(t)}(v) is the set of labels associated with the node v for the label type i and the iteration t. If the vertex v does not have class labels, the attribute labels Lᵢ(v) are chosen. After the labels have been chosen, one learning iteration of UL is performed. In the end, for each node, the embeddings learned for each label type are kept and the class label embeddings are discarded.

Various manifold learning algorithms such as multidimensional scaling (MDS), Laplacian Eigenmap, ISOMAP and Locally Linear Embedding (LLE) construct an affinity graph first and embed the data points into a low-dimensional space. The corresponding optimization problems often have to be solved in a closed form (for instance, due to the constraints in the objective that avoid degenerate solutions) which is intractable for large graphs. There are also graph-based semi-supervised methods such as label propagation wherein the class label is predicted by applying the so-called “arg max” operation to the label distribution of nodes. EMBEDNN is a method that combines an unsupervised learning objective with an existing supervised loss. A similar idea is followed by PLANETOID which combines more recent graph-based unsupervised learning methods with a supervised loss.

Several unsupervised learning frameworks are applicable to address the node classification problem by learning node representations. DEEPWALK is an unsupervised learning framework that collects random walks on the graphs and applies a SKIPGRAM model to learn node representations. This model uses a similarity-based measure for learning the node representations, however, distance-based measures are closely related and can be seen as the inverse of the similarity-based measures. LINE is another unsupervised learning framework wherein the learning is based on similarities between pairs of nodes. None of these unsupervised learning frameworks take advantage of node attributes. On the other hand, EP is an unsupervised learning framework that can incorporate node attributes. However, in contrast to an embodiment of the present invention, such as S-EP, EP is not semi-supervised in that it does not leverage class label information during node representation learning, and is therefore not able to learn classifier-agnostic representations.

There is a growing number of graph-based neural network based learning frameworks such as graph neural networks (GNN), gated graph sequence neural networks (GG-SNN), diffusion-convolutional neural networks (DCNN), and graph convolutional networks (GCN). Such methods can be described as instances of the Message Passing Neural Network (MPNN) framework where messages are passed between nodes to update their representations. The training of these instances is guided by a supervised loss, as in the other semi-supervised methods prior to the present invention. The combination of different node attributes is also not addressed and a concatenation of the input features can only be assumed. All existing semi-supervised approaches prior to the present invention are bound to the classification function used in the supervised learning objective.

Graph-based learning approaches can make a smoothness assumption: the closer two nodes are in the graph the more likely it is that they have the same class labels. This assumption leads to the generic loss function:

Σ_{i∈L}l(yᵢ,ƒ(xᵢ))+λΣ_{i,j∈L∪U} [symbol] (h(xᵢ),h(xᵢ),W_{i,j}) (1)

where L∪U is the set of instances (the first L being labeled), xᵢ∈ [symbol] ⁿ and yᵢ∈ [symbol] are the raw feature vectors of the instance i and its class label respectively, and W is a (weighted or binary) affinity matrix. Here, l is a supervised and [symbol] an unsupervised loss function. In the above term ƒ: [symbol] ⁿ→ [symbol] is a differentiable classification function and h either an embedding function h: [symbol] ⁿ→ [symbol] ^{n′} or ƒ itself. The second term of the loss function is the graph-based regularization term. Most graph-based semi-supervised learning methods use an instance of the above loss function with different ƒ, h, l and [symbol] . Hence, the methods are not classifier-agnostic due to the specific classification function f used in Equation (1). Some recent methods encode the graph structure directly with a neural network based model ƒ(X, W), where X is the matrix of feature vectors and ƒ a classification function. The loss is purely supervised and, therefore, these methods avoid the graph-based regularization term in Equation (1). Instances are graph convolutional networks for semi-supervised learning and mixture model convolutional neural networks (CNNs). All of these methods, however, are tailored to the classifiers ƒ used in the supervised loss functions.

Table 1 below shows a comparison of different graph-based learning approaches. Semi-supervised approaches are those methods leverage class label information during node representation learning. Node attributes indicate the ability of the different approaches to incorporate node attributes. Classifier-independent indicates that the learning is not tailored to a specific classification function. S-DEEPWALK and S-EP designate embodiments of the present invention. Both PLANETOID and MPNN instances are able to incorporate node attributes. EMBEDNN is both semi-supervised and able to incorporate node attributes. These three methods are, however, not classifier-agnostic since they use a supervised loss with a specific classification function. Unsupervised learning approaches such as DEEPWALK and EP are classifier-independent but do not learn representations that carry class label information. S-EP is the only approach that learns classifier-agnostic representations while taking advantage of node attributes.

TABLE 1

| | Node | Semi- | Classifier- | Classifier- |
|---|---|---|---|---|
| Method | Attributes | supervised | independent | agnostic |
| EMBEDNN | Yes | Yes | No | No |
| DEEPWALK/ | No | No | Yes | Yes |
| NODE2VEC | | | | |
| PLANETOID | Yes | Yes | No | No |
| MPNN (GCN, | Yes | Yes | No | No |
| GNN, etc.) | | | | |
| EP | Yes | No | Yes | No |
| S-DEEPWALK | No | Yes | Yes | Yes |
| S-EP | Yes | Yes | Yes | Yes |

Two types of unsupervised learning frameworks for node representation learning on graph-structured data include a first type which generates random walks and applies word embedding methods, and a second type which is based on passing embeddings between neighboring nodes and applying a distance-based loss computed between the embedding of a node and its reconstruction from embeddings of neighboring nodes.

In this case, a graph G=(V, E) can consist of a set of vertices V and a set of edges E⊂{(v,w)|v, w∈V}. The graph G can be associated with k label types L₁, . . . , Lₙ, where each Lᵢ is a set of labels (values) corresponding to label type i. Besides these label types, class labels L^{C} are a kind of label type that is only available for some nodes of the graph.

In most existing semi-supervised approaches, the learning objective consists of two parts. The first part is a supervised loss measuring the degree to which class labels can be predicted by the model. The second part consists of an unsupervised loss defined over a distance of pairs of node embeddings. The core idea of the unsupervised loss is to make embeddings of nodes similar if they are strongly connected in the graph and dissimilar if they are only weakly connected or not connected at all. By combining the supervised and unsupervised loss, the model can take advantage of data points without class label information.

According to embodiments of the present invention, unsupervised learning frameworks such as the two types based on random walk and message passing, are improved in that class label information is injected into the learned embeddings. Embodiments of the present invention are applicable to a large number of graph-based learning approaches such as DEEPWALK, LINE, GRAPHSAGE and EP. In addition to performance improvements provided by embodiments of the present invention owing to the learned class label embeddings, embodiments of the present invention do not require additional hyperparameters and the model complexity remains almost the same as in the unsupervised learning frameworks.

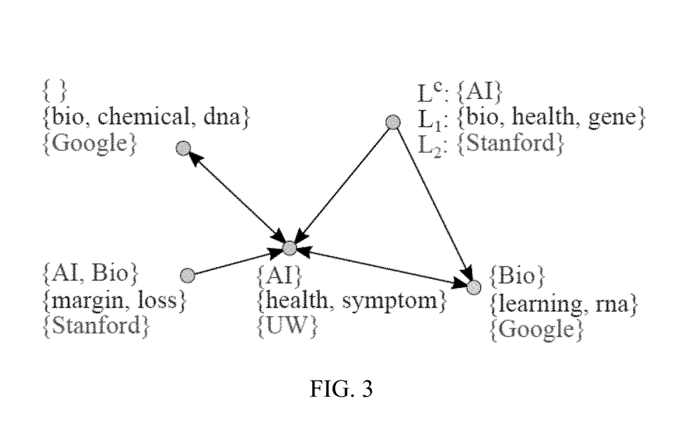

FIG. 3 shows a small part of a graph 11 with nodes 16 and three label types. In this particular medical data set represented in the graph, the label type L^{C} represents the class labels 17, L₁ represents words in the titles of papers and L₂ is the affiliation of the first author as label types 18. According to embodiments of the present invention, class label information is injected into the learned node representations.

According to an embodiment of the present invention, class label information is injected into node representations learned via random walks, for example DEEPWALK, which is fundamentally tied to the label type L that corresponds to the node identifiers. It uses truncated random walks to learn latent representation by treating walks as the equivalent of sentences. It consists of two main components, a random walk generator and a word embedding method to learn the node representations from the set of walks. The random walk generator constructs, for each node in the graph, a fixed number of random walks of length M. A window of size 2m+1 is then moved over these walks and, for each center vertex v_{c} in each such window, the negative log likelihood −log P (v_{c-m}, . . . , v_{c-1}, v_{c+1}, . . . , v_{c+m}|v_{c}) of the vertices in the window given the vertex v_{c} is minimized. The SKIPGRAM model makes the assumptions that (a) the vertices in the context window are mutually independent given the central node v_{c} and (b) the probability P(v|v_{c}) is proportional to the dot product v^{T}v_{c}. These assumptions result in the log loss function:

Σ_{j=o,j≠m}^{2m}v_{c-m|+j}^{T}v_{c}+2m log Σₖ₌₁^{|V|} exp(vₖ^{T}v_{c}) (2)

where v∈ [symbol] ^{d} is the embedding of vertex v. To make the computation of the gradients more efficient, negative sampling can be performed.

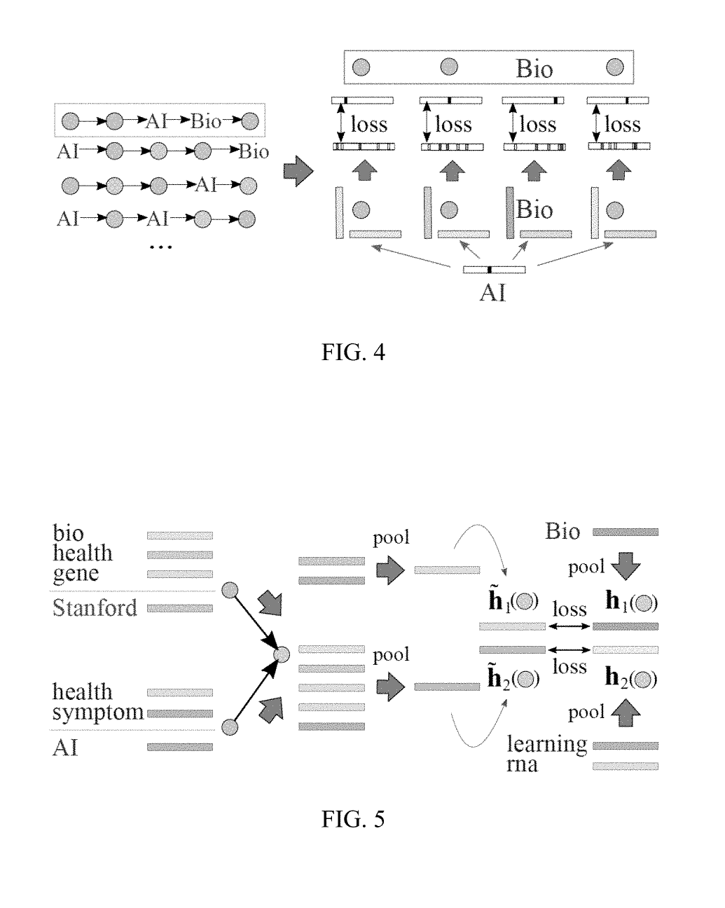

FIG. 4 schematically shows how random walk-based node embedding methods such as DEEPWALK and NODE2VEC generate fixed size paths and learn vertex embeddings by training the model to predict each context vertex's one-hot encoding from the vertex center. To inject class label information, the class or attribute label is uniformly sampled for each node and the loss is computed based on the model's ability to predict the one-hot encodings of the sampled labels. Referring to Algorithm 1 in FIG. 2, random walks are performed in the graph G and, for each visited node v, L^{(t)}(v), the label set associated with v for iteration t, is sampled from {L(v), L^{C} (v)}. If the vertex does not have class labels, that is, |L^{C} (v)|=0, it is provided to set L^{(t)}(v)=L (v). Hence, the generated sequences consist of both node identifier labels and class labels. The resulting sequences are fed to the SKIPGRAM model with vocabulary L∪L^{C}. FIG. 4 illustrates the learning steps. In the end, the class label embeddings are discarded as the classification function in this instance cannot be trained using as input class label information, which does not exist at test time and must be predicted by the classification function.

According to another embodiment of the present invention, class label information is injected into node representations learned via message passing such as EP. The general learning framework of EP proceeds in two separate steps. First, EP learns a vector representation for every label by passing messages along the edges of the input graph. In EP, there can be several label types L₁, L₂, . . . , Lₙ, each of which represents a set of labels belonging to a particular attribute such as the words associated with a paper in a citation network (see FIG. 3). For each label type, an appropriate embedding function f such as a linear embedding function for text is selected. This learnable function f maps every label [symbol] of type i to its embedding [symbol] ∈ [symbol] ^{d}^{ᵢ}, that is, [symbol] =fᵢ( [symbol] ). In each propagation step, for each node v in the graph, and for each label type i, the embeddings of labels of type i of v's neighbors nodes are aggregated into a vector [symbol] (v) and a reconstruction loss is computed between [symbol] (v) and hᵢ(v), the aggregation of v's embeddings of labels of type i. Hence, the aggregation of the label embeddings of v's neighbors are made close to the aggregation of v's own label embeddings. A simple instance of the EP framework results from setting the aggregation to be the average pooling operation.

FIG. 5 illustrates the working of embedding propagation on a simple graph for a single node (learning step). EP passes messages between nodes and computes a loss based on the distance between a node's label embedding and its reconstruction from neighboring embeddings of the same label type. A distance-based loss can be used, such as the margin-based ranking loss:

Σ_{v∈V}Σ_{u∈C\{v}}[γ+dᵢ(\tilde{h}ᵢ(v),hᵢ(v))−dᵢ(\tilde{h}ᵢ(v),hᵢ(u)]₊ (3)

where dᵢ is the Euclidean distance, [x]₊ is the positive part of x, and γ>0 is a margin hyperparameter. Hence, the objective is to make the distance between [symbol] (v), the approximated embedding of label type i for vertex v, and hᵢ(v), the current embedding of label type i for vertex v, smaller than the distance between [symbol] (v) and hᵢ(u) the embedding of label type i of a vertex u different from v. The minimization problem is solved with gradient descent algorithms and uses one node u for every v in each learning iteration. One embedding for each of the labels associated with the graph results after the learning is complete. In a second step, EP computes a vector representation for each vertex v from the vector representations of v's labels. This can be a simple concatenation of the aggregations of the labels of each type: v=concat[h₁(v), . . . , hₖ(v)]. To inject class label information, the class (if they exist) or attribute labels are uniformly sampled for each node before each learning iteration and class labels are treated as ordinary attribute labels in the computation of the loss. One copy of the class labels a is maintained for each of the attribute label types i∈{1, . . . , n}. For each of these copies, a distinct embedding specific to the respective label types is learned. Prior to each learning iteration t, for each vertex v, and each label type i, Lᵢ^{(t)}(v) is sampled uniformly at random from {Lᵢ(v), Lᵢ^{C}(v)}. If the vertex v does not have class labels, the attribute labels Lᵢ(v) are chosen. After the labels have been chosen, one learning iteration of EP is performed. In each learning step and for each node v, therefore, v's class label embedding or aggregated attribute label embedding is reconstructed from a mix of attribute and class label embeddings coming from v's neighbors. FIG. 5 illustrates one learning step of the classifier-agnostic version of EP according to an embodiment of the present invention, also referred to herein as S-EP. In the end, the pooled attribute label embeddings are concatenated and the class label embeddings are discarded.

Algorithm 1 (see FIG. 2) illustrates the steps for injecting the class label information according to an embodiment. Before each learning step, the nodes of the graph are associated uniformly at random with either the attribute labels or the attribute-specific class labels if they exist. This means that attribute-specific class label embeddings have the same dimensionality as the attribute's. The applicability of Algorithm 1 is not only limited to DEEPWALK and EP but can also be combined with all unsupervised learning methods that apply a distance-based loss function between node embeddings such as LINE and GRAPHSAGE.

Embodiments of the present invention also provide a mechanism to incorporate sequence data into the unsupervised framework described in U.S. patent application Ser. No. 15/593,353, which is hereby incorporated by reference herein, wherein the technique to learn classifier-agnostic representations is also applicable. This application provides a more detailed explanation of the framework. One characteristic of such framework is that it embeds the labels [symbol] of a label type i into an embedding 1 with an embedding function fᵢ, that is 1=fᵢ( [symbol] ). The embedding l is a sequence of T n-dimensional vectors (l₁, . . . , l_{T}), and a Gated Recurrent Units (GRU) is used to map the sequence of n-dimensional vectors to a single embedding. GRU is defined by the following recursion:

zₜ=σ_{g}(W_{z}lₜ+U_{z}hₜ₋₁+b_{z})

rₜ=σ_{g}(Wᵣlₜ+Uᵣhₜ₋₁+bᵣ)

hₜ=zₜ∘hₜ₋₁+(1−zₜ)∘(Wₕlₜ+Uₕ(rₜ◯hₜ₋₁)+bₕ)

where zₜ, rₜ and hₜ are the update gate vector, the reset gate vector and the state vector, respectively. σ_{g} is a sigmoid function. We learn a representation for [symbol] ΣLᵢ a sequence of length T with the embedding function:

$${f}_{i} ( 𝓁 ) = \frac{1}{T} {\sum }_{t = 1}^{T} {h}_{t} \qquad ( 4 )$$

Accordingly, each sequence of vectors is embedded into a single representation by making use of a recurrent network. Prior to the present invention, it has not been possible incorporate sequential data into a graph-based learning method. This is especially advantageous when needing to work with sequence data, which is very often the case in some domains, such as the medical domain, wherein genomics or biomarkers are usually encoded as sequences of vectors.

Embodiments of the invention are tied to graph-based unsupervised learning methods. This assumes that, for every data set, a graph structure is either given or can be induced based on some similarity measure among data points.

For data sets where the graph has to be induced, an embodiment of the present invention provides for execution of the following:

I) Given N input samples, the first step is to compute a similarity score between all pairs of input samples using a similarity function. This creates a full adjacency matrix A (of dimensionality N×N).
II) The matrix A is sparsified to produce the final graph G=(V, E). Sparsification is particularly advantageous since it leads to improved efficiency in the representation learning stage, better accuracy and robustness to noise.

An example of a sparsification algorithm is the k-nearest neighbors algorithm: each input sample is connected to the k most similar input samples.

The technique according to embodiments of the present invention is general and applicable to any classification problem wherein the class label of only a portion of the input samples is known.

Particular applications in which the technique can be employed to improve the accuracy in classification problems include medical data, e.g., in the biomedical domain, news classification, music genre categorization, etc.

In the biomedical domain, where the human annotators need to be highly skilled professionals, these annotation tasks to label samples can become very expensive. Although vast amounts of unlabeled medical data are available, labeled data that can be used for training purposes continue to be relatively scarce. Examples of input data are: medical images, or clinical, genomic (sequence data) and biomaker data, each with their corresponding class labels (e.g. disease/non-disease).

The categorization of news articles into categories (e.g. science, entertainment, etc.) is important for online newspapers. A good categorization of news articles makes it easier to make better personalized recommendations to users according to their interests. Experiments (in the 20Newsgroup data set) support the benefits of using classifier-agnostic representations to improve the classification accuracy.

Similarly, online music distributors can benefit from having a better categorization of music clips. Experiments (in the FMA data set) support the benefits of using classifier-agnostic representations to improve the music genre prediction accuracy.

Advantages provided by embodiments of the present include providing a mechanism to learn classifier-agnostic representations within unsupervised learning frameworks. The advantages of classifier-agnostic representations are i) they carry class label information, but still ii) they can be used in conjunction with any arbitrary classification model. This is a clear advantage, since it is well-known there is not one classification method outperforming all others. The usage of class label information within unsupervised learning frameworks leads to a higher accuracy in classification problems. The usage of class label information without a supervised loss makes the learned representations classifier-independent. Therefore, one can evaluate any classification model (even non-differentiable classification models) without retraining the model for the specific classification function. This leads to a reduction in the amount of computational resources required and to a higher accuracy with respect to a semi-supervised approach in case the best performing classification function is non-differentiable. Advantages provided by embodiments of the present also include providing a mechanism to incorporate sequence data into the framework to learn classifier-agnostic representations.

According to an embodiment of the present invention, a method for learning classifier-agnostic representations comprises the steps of

1) Induce a graph in a case in which a graph is not given. There are several mechanisms for graph construction.
2) Select a graph-based unsupervised learning framework, wherein the node representation learning is done by applying a distance-based or similarity-based loss between node representations by exchanging messages iteratively.
3) Run Algorithm 1—Inputs: graph (given or induced), associated label types, and the chosen unsupervised learning method. Embeddings are learned not only for the nodes of the graph, but also for their class labels, if they exist. The embeddings of the class labels are at the same time learned and injected into the node representations of the graph.

The advantages of the technique according to embodiments of the present invention have been empirically proven on two different unsupervised learning frameworks in six different data sets for different proportions of labeled data.

The experiments (1) verify that classifier-dependent embeddings achieve their best performance only with the classification function used in the supervised loss, (2) demonstrate the extent to which the induction of class label information into the unsupervised learning frameworks such as DEEPWALK and EP can improve the accuracy on node classification problems in cases where the graph is given but also in cases when an affinity graph has to be induced first. The accuracy of methods according to embodiments of the present invention are compared with state of the art unsupervised and semi-supervised methods. Further, the experiments (3) compare the embodiment of S-EP that incorporates sequential data according to an embodiment of the present invention against the instance that does not take the dynamic behavior of sequences into account, and show that classifier-agnostic representations can also be learned for sequence data.

As in previous works, the following data sets were used: Cora, Citeseer and Pubmed. These data sets consist of citation networks where nodes represent scientific articles with their corresponding bag-of-words, and edges express citations between articles. Each class label represents a main research topic. Referring to Table 2 below, Yeast contains numerical attributes about cells and the goal is to determine cellular localization. 20 Newsgroups is a collection of newsgroup documents partitioned evenly across twenty different categories. FMA is a recent data set for music analysis, in which 30-seconds audio clips are extracted from the middle of the tracks and mp3-encoded with a sampling rate of 44,100 Hz. According to an embodiment of the present invention, the small data set was applied and the method was used to perform genre prediction. For each of the clips, the Mel Frequency Cepstral Coefficients (MFCC) were extracted. First, 20 MFCC were computed on windows of 2,048 samples spaced by hops of 512 samples and seven statistics are then computed over all windows for each of the 20 MFCC: the mean, standard deviation, skew, kurtosis, median, minimum and maximum. This amounts to 140-dimensional features. Both Yeast and FMA are standardized to make each feature have zero-mean and unit-variance. A modification of the FMA dataset was also constructed, called FMA (Seq), that preserves the temporal information of the 30-seconds music clips. To do so, in the second step of the construction of the FMA data set, the seven aggregation features were not computed over all windows, but over the windows contained in each of the 30 seconds. As a consequence, each music clip is characterized by thirty 140-dimensional vectors. Table 2 shows the statistic of the data sets. In the top data sets of Table 2, a graph structure is given and, in the bottom data sets an affinity graph was constructed as described above.

TABLE 2

| Data set | \|V\| | \|E\| | #classes | Features | Type |
|---|---|---|---|---|---|
| Cora | 2,708 | 5,429 | 7 | 1,433 | BoW |
| Citeseer | 3.327 | 4,732 | 6 | 3,703 | BoW |
| Pubmed | 19,717 | 44,338 | 3 | 500 | BoW |

| Data set | #samples | #classes | Features | Type |
|---|---|---|---|---|
| 20 Newsg | 18,846 | 20 | 13,276 | BoW |
| Yeast | 1.484 | 10 | 8 | Num |
| FMA | 8,000 | 8 | 140 | Num |
| FMA (Seq) | 8,000 | 8 | 30 × 140 | Num |

The input to the node classification problem is a graph (given or induced) where a number of the nodes is assigned a class label. The output is an assignment of class labels to the test nodes. Using the classification data sets, the performance of semi-supervised and unsupervised instances of EP and DEEPWALK (or DW) were compared with:
GCN: For the data sets Cora, Citeseer and Pubmed the hyperparameter values reported in Kipf et al., “Semi-supervised classification with graph convolutional networks,” arXiv preprint arXiv: 1609.02907 (2016) were used for these same data sets. As GCN has not been previously applied to Yeast, FMA and 20 Newsgroups, the latent dimension on validation set and the rest of hyperparameters remain the same.
FEAT: This baseline trains a logistic regression classifier on the input features. The goal of this baseline is to show whether representation learning methods (unsupervised and semi-supervised) can lead to improvement over the “raw” features on classification problems.
LLE: LLE seeks a lower-dimensional projection of the data which preserves distances within local neighborhoods.
ISOMAP: ISOMAP seeks a lower-dimensional embedding which maintains geodesic distances (the number of edges of the shortest path) between all points.

For the baselines FEAT, LLE and ISOMAP, the implementations of scikit-learn were used. For DEEPWALK, the implementation of NODE2VEC (setting p=0 and q=0) and was used and S-DEEPWALK was built on that code.

For all data sets and all methods, the latent dimension d (for simplicity, dᵢ=d∀i in the learning framework EP) was chosen on the validation data from the values [8, 16, 32, 64, 128]. For all classifier-independent approaches, after node embeddings are learned, a number of nodes were sampled uniformly at random and their embeddings and class labels were used as training data for a classification model. For the classifier-dependent approaches, the class labels of the sampled nodes are directly used as input to the models. For the data sets where the graph is given (Cora, Citeseer and Pubmed), Tᵣ nodes were sampled per class. Tᵣ=20 as in previous works was used for these same data sets, as well as higher values to have a better understanding of the impact of the class label induction into EP and DEEPWALK. For the data set where the graph has to be induced (Yeast, FMA and 20 Newsgroups), the class label of a fraction Fᵣ % of the nodes to train the classification function was used.

In addition to the logistic regression classification function used in previous unsupervised learning frameworks, k-NN and linear SVM were evaluated in Cora, Citeseer and Pubmed. These classification functions are ones that can easily be found in a production system. When using logistic regression classifier, the L2 regularization hyperparameter was determined on validation data from the values [0.001, 0.01, 0.1, 1, 10]. This was done for each method and each value of Tᵣ or Fᵣ. When using k-NN, the choice of k is also validated from the values [1, 3, 5, 7, 9]. For the SVM, the cost hyperparameter was validated among the same values as for the L2 regularization parameter of the linear SVM. The scikit-learn implementations of these classification functions were used. The default strategy of the implementation, namely one-vs-rest, was used to turn binary classifiers, such as linear regression (LR) and SVM, into multiclass ones.

For all data sets, except FMA (Seq), and all label types the functions fᵢ of EP are linear dense (fully connected) layers. Note that for the data sets whose features are bag-of-words this is equivalent to an embedding lookup table. The margin γ of EP was chosen from the set of values [1, 5, 10] on validation data. Except for the latent dimension, the rest of hyperparameters (length of walks per node, context size, etc.) of DEEPWALK were fixed to the values reported in the NODE2VEC paper by Grover, et al.

GCN, as considered in Kipf, et al. consists of two layers. The first layer outputs the latent representation of nodes, whose dimensionality is validated among the previously mentioned values, and the second one outputs a label distribution of nodes via multinomial logistic regression. To validate that classifier-dependent representations achieve their best performance only in conjunction with the specific classification function of the supervised loss, the node representations (output of the first layer) of the GCN trained with its validated hyperparameters were taken and used as input to train other classification models. The hyperparameters of EP and DEEPWALK were validated for the case when a logistic regression model is used as the classification function, and used these same learned node representations were used as input to the other classification functions (k-NN and SVM).

For the data sets Cora, Citeseer, Pubmed, FMA/FMA (Seq) and 20 Newsgroups, 1,000 nodes were sampled as test data, and a different 1,000 nodes were sampled as validation data for each value of Tᵣ or Fᵣ. This experimental procedure has been followed in the previous works by Kipf, et al. and Garcia-Duran, et al. for the three first data sets. Because of its small size, for Yeast, only 500 nodes were sampled as test data, and a different set of 500 nodes were sampled as validation data.

For the non-graph-based data sets (Yeast, FMA and 20 Newsgroups), a graph is not given by the data sets and has to be induced in the first place. Both LLE and ISOMAP explicitly build a graph (weighted in the case of LLE) by determining the K nearest neighbors based on some distance or similarity measure for each data point. A similar procedure was followed for GCN, DEEPWALK and EP: a K-nearest neighbor graph is constructed based on a suitable similarity metric. For 20 Newsgroups whose features are bag-of-words (BoW), the Jaccard index was used as a similarity metric, which is appropriate for measuring similarities between sets of elements. On the other side, for Yeast and FMA, the Euclidean distance on the previously standardized features was used to induce a K-nearest neighbor graph. K is chosen from [5, 10, 20] on validation data. To ensure a fair comparison the same similarity metrics were used in LLE and ISOMAP to determine the K nearest neighbors.

Ten runs were performed for each method in each of the experimental set-ups described above, and the mean and standard deviation of the corresponding evaluation metrics were computed. The same training, validation, and test sets were used for each method.

For EP and S-EP, the so-called ADAM optimization algorithm was used to learn the parameters in a mini-batch setting with a learning rate of 0.001. A single learning epoch iterates through all nodes of the input graph. The number of epochs was set to 200 and the minibatch size was set to 64. The parameters were initialized following Glorot, et al., “Understanding the difficulty of training deep feedforward neural networks,” In proceedings of the 13th Int'l Conf on A.I. and Stats., pp. 249-256 (2010) and the learning always converged. They were implemented with Keras, an open source neural network library, written in Python. All experiments were run on commodity hardware with 128 GB RAM, a single 2.8 GHz CPU, and a TitanX GPU. In Tables 3-5, the abbreviation PREFIX-METHOD is used to refer to the different instances of EP and DEEPWALK (for example, S-EP and S-DW according to embodiments of the present invention. The classification function used on the node representations is indicated in parenthesis. The best results are indicated in bold.

The results for Cora, Citeseer and Pubmed are listed in Table 3 below, which are split into three categories: baselines, unsupervised learning frameworks and unsupervised learning frameworks modified according to the method according to the an embodiment of the present invention to inject class label information into the node representations. The upper part of Table 3 lists results of the two baselines. The middle and lower part of Table 3 shows the results of DEEPWALK (DW) and EP with and without classifier-agnostic learning, respectively. Tᵣ is the number of nodes per class with class labels (values in parenthesis lists the corresponding percentage). The best result within each category is indicated in italics.

TABLE 3

| | Citeseer | | |
|---|---|---|---|
| Tr [~%] | 20 [3.5%] | 50 [9%] | 100 [18%] |
| FEAT (LR) | 59.1 ± 1.8 | 65.4 ± 1.8 | 68.8 ± 1.5 |
| FEAT (Knn) | 30.8 ± 5.4 | 31.6 ± 4.1 | 32.5 ± 4.2 |
| FEAT (SVM) | 57.4 ± 1.0 | 62.6 ± 1.8 | 65.7 ± 2.2 |
| GCN | 69.2 ± 1.2 | 71.9 ± 1.6 | 74.2 ± 1.0 |
| GCN (LR) | 68.2 ± 1.4 | 71.2 ± 1.4 | 74.2 ± 1.3 |
| GCN (Knn) | 67.1 ± 1.9 | 71.0 ± 1.5 | 73.1 ± 1.4 |
| GCN (SVM) | 67.4 ± 1.8 | 70.7 ± 1.5 | 73.4 ± 1.2 |
| | without class label induction | | |
| DW (LR) | 48.5 ± 2.5 | 52.9 ± 1.5 | 54.2 ± 2.3 |
| DW (kNN) | 43.5 ± 2.7 | 49.5 ± 1.7 | 54.2 ± 1.3 |
| DW (SVM) | 48.2 ± 1.9 | 49.5 ± 1.7 | 54.3 ± 2.1 |
| EP (LR) | 70.5 ± 1.7 | 72.2 ± 1.4 | 73.5 ± 1.5 |
| EP (kNN) | 66.5 ± 1.7 | 68.5 ± 1.0 | 70.0 ± 1.4 |
| EP (SVM) | 69.0 ± 1.9 | 70.8 ± 0.9 | 71.3 ± 1.4 |
| | with class label induction | | |
| S-DW (LR) | 48.5 ± 2.2 | 54.4 ± 1.9 | 59.3 ± 1.6 |
| S-DW (kNN) | 48.4 ± 2.6 | 54.2 ± 2.4 | 58.6 ± 1.2 |
| S-DW (SVM) | 48.6 ± 2.1 | 54.3 ± 1.9 | 60.0 ± 1.4 |
| S-EP (LR) | [symbol] | [symbol] | [symbol] |
| S-EP (kNN) | 67.5 ± 1.9 | 70.1 ± 1.2 | 73.7 ± 1.1 |
| S-EP (SVM) | 69.1 ± 1.7 | 71.9 ± 1.4 | 74.4 ± 1.2 |
| | Cora | | |
| Tr [~%] | 20 [5%] | 50 [13%] | 100 [26%] |
| FEAT (LR) | 58.7 ± 1.9 | 65.9 ± 1.5 | 69.9 ± 1.5 |
| FEAT (Knn) | 31.3 ± 6.9 | 35.5 ± 4.9 | 40.7 ± 4.3 |
| FEAT (SVM) | 57.7 ± 2.5 | 64.7 ± 1.5 | 69.4 ± 0.9 |
| GCN | [symbol] | [symbol] | 84.9 ± 0.9 |
| GCN (LR) | 77.5 ± 1.8 | 81.4 ± 1.5 | 83.7 ± 0.9 |
| GCN (Knn) | 77.1 ± 2.4 | 81.4 ± 1.5 | 83.5 ± 1.0 |
| GCN (SVM) | 76.7 ± 2.8 | 81.3 ± 1.8 | 84.0 ± 1.2 |
| | without class label induction | | |
| DW (LR) | 71.8 ± 1.6 | 74.7 ± 1.6 | 77.0 ± 1.0 |
| DW (kNN) | 68.9 ± 2.3 | 72.5 ± 1.7 | 75.5 ± 1.4 |
| DW (SVM) | 71.0 ± 2.0 | 74.9 ± 1.7 | 78.1 ± 0.8 |
| EP (LR) | 76.9 ± 2.2 | 79.5 ± 1.8 | 80.1 ± 1.4 |
| EP (kNN) | 74.1 ± 1.8 | 77.9 ± 1.8 | 80.0 ± 1.3 |
| EP (SVM) | 76.2 ± 2.1 | 79.4 ± 2.2 | 81.3 ± 1.2 |
| | with class label induction | | |
| S-DW (LR) | 72.5 ± 1.7 | 75.6 ± 1.8 | 79.1 ± 1.6 |
| S-DW (kNN) | 68.5 ± 1.9 | 72.2 ± 1.5 | 76.1 ± 1.1 |
| S-DW (SVM) | 70.7 ± 1.9 | 81.1 ± 1.2 | 83.5 ± 1.2 |
| S-EP (LR) | 77.2 ± 2.1 | 81.1 ± 1.2 | 83.5 ± 1.2 |
| S-EP (kNN) | 76.5 ± 1.6 | 82.2 ± 2.2 | 84.4 ± 0.8 |
| S-EP (SVM) | 76.1 ± 2.0 | 81.9 ± 1.6 | [symbol] |

| | Pubmed | | |
|---|---|---|---|
| Tr [~%] | 20 [.3%] | 100 [1.5%] | 1000 [15%] |
| FEAT (LR) | 70.6 ± 2.5 | 79.4 ± 2.0 | 85.0 ± 0.5 |
| FEAT (Knn) | 55.8 ± 2.5 | 62.4 ± 2.2 | 72.5 ± 1.0 |
| FEAT (SVM) | 69.0 ± 2.1 | 78.4 ± 1.7 | 85.0 ± 0.8 |
| GCN | 77.3 ± 2.6 | 83.4 ± 1.2 | 85.5 ± 1.0 |
| GCN (LR) | 76.0 ± 2.0 | 83.1 ± 0.9 | 85.7 ± 1.2 |
| GCN (Knn) | 76.2 ± 1.4 | 82.9 ± 1.1 | 85.7 ± 1.0 |
| GCN (SVM) | 76.3 ± 1.7 | 83.3 ± 1.1 | 85.7 ± 1.1 |
| | without class label induction | | |
| DW (LR) | 73.5 ± 2.6 | 78.8 ± 1.2 | 79.8 ± 1.5 |
| DW (kNN) | 69.1 ± 2.2 | 76.3 ± 1.1 | 78.9 ± 1.5 |
| DW (SVM) | 74.1 ± 2.0 | 78.6 ± 1.2 | 80.1 ± 1.3 |
| EP (LR) | 79.4 ± 2.0 | 84.1 ± 0.4 | 85.7 ± 0.9 |
| EP (kNN) | 73.6 ± 3.7 | 81.2 ± 1.1 | 84.7 ± 1.0 |
| EP (SVM) | 79.3 ± 1.5 | 83.6 ± 1.2 | 85.6 ± 1.3 |
| | with class label induction | | |
| S-DW (LR) | 73.4 ± 1.9 | 78.8 ± 1.0 | 81.3 ± 1.6 |
| S-DW (kNN) | 69.1 ± 3.6 | 76.6 ± 1.1 | 79.5 ± 1.7 |
| S-DW (SVM) | 79.8 ± 1.9 | 84.7 ± 0.7 | 86.5 ± 0.8 |
| S-EP (LR) | 79.8 ± 7.9 | [symbol] | 86.5 ± 0.8 |
| S-EP (kNN) | 72.4 ± 3.4 | 79.5 ± 1.5 | 83.1 ± 0.7 |
| S-EP (SVM) | [symbol] | [symbol] | [symbol] |

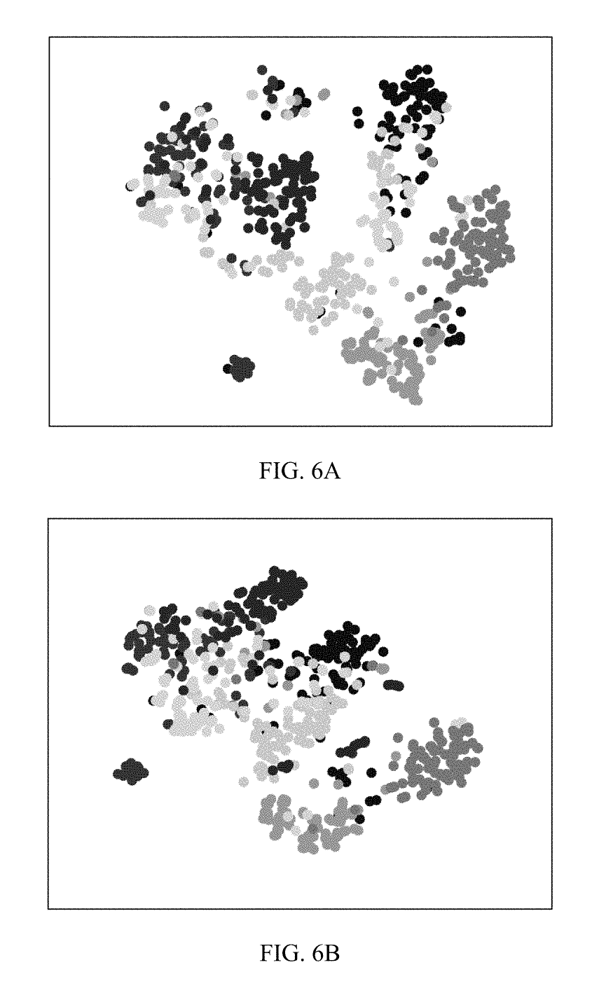

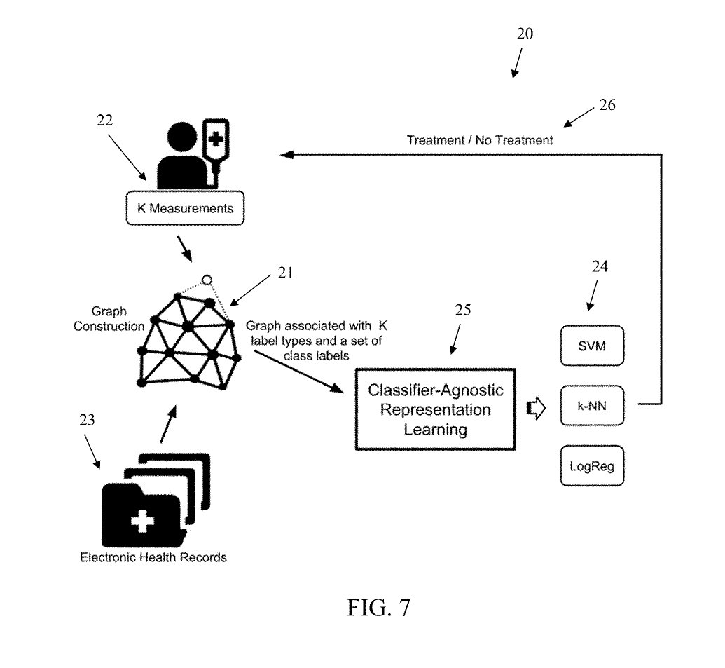

FIGS. 6A and 6B are visualizations of 700 sampled nodes (100 per class label) of the Cora citation network. The two-dimensional vectors were generated by applying t-sne to the 128-dimensional embeddings generated by EP (FIG. 6A) and S-EP (FIG. 6B) for the 100 [26%] setting. The Silhouette score, a measure of clustering quality ranging from −1 to 1 (with the higher score being better), was 0.140 for EP and 0.196 for S-EP.

As expected, GCN achieves the best performance with the classification function tailored to its supervised loss in all cases except in one, for Tᵣ=1000 in Pubmed the other classification functions show a slight improvement. The unsupervised learning methods EP and DEEPWALK are significantly outperformed by their semi-supervised counterparts for the classification models evaluated in this work, especially when the percentage of labelled data is above 5%. In the case the percentage of labeled nodes is small (e.g. 5% or less), the performance of a run can deteriorate with only few non-representative nodes, and as a consequence the average performance slightly degrades. According to an embodiment of the present invention, the learning framework could be extended to address this situation by replacing the uniform sampling by a Bernouilli sampling wherein the class labels are sampled with a probability p. Contrary to GCN, whose classifier-dependent embeddings consistently achieved their best performance only with the classification function tailored to GCN, for SEP and S-DW there is not a best-performing classification function. The induction of class label information improves the accuracy of DEEPWALK and EP up to 3.7% and 5.7% respectively, with the advantage of not requiring additional hyperparameters. Though DEEPWALK cannot make use of node attributes, in practice there are many data sets for which the graph structure is the only available information. Contrary to EP, S-EP is competitive and even sometimes outperforms the semi-supervised method GCN for the highest percentage of labeled data. It is also noticeable the performance of FEAT (k-NN), which confirms the inappropriateness of using the Euclidean distance to calculate distances between BoW.

The results for Yeast, 20 Newsgroups and FMA are listed in Table 4 below. Due to the good overall performance of LR across data sets and different values of Tᵣ in Table 3, for the remaining experiments, LR was used as the classification function. It was observed that GCN's performance dramatically deteriorates for the data sets (Yeast and FMA) whose features are numeric. Kipf, et al. showed GCN's suitability on data sets whose features are BoW; similarly, its suitability is here proved in another data set containing BoW, 20 Newsgroups. Overall, the performance of ISOMAP is comparable to that of DEEPWALK, but considerably lower than that of EP. In ISOMAP, LLE and DEEPWALK, the features are used to only induce a graph (weighted in the case of LLE). GCN and EP use the node attributes during the node representation learning phase. FEAT is shown to be a strong baseline for these data sets, and only S-EP systematically outperforms it. It was also observed that DEEPWALK and EP are systematically outperformed by their semi-supervised counterparts in these data sets when the percentage of labelled data is above 5%.

TABLE 4

| | Yeast | | |
|---|---|---|---|
| Pᵣ | 5 | 10 | 20 |
| FEAT (LR) | 53.5 ± 3.0 | 55.6 ± 1.6 | 56.9 ± 2.1 |
| LLE (LR) | 34.0 ± 1.5 | 37.0 ± 2.0 | 40.3 ± 1.8 |
| ISOMAP (LR) | 52.0 ± 2.9 | 52.4 ± 2.7 | 53.8 ± 2.7 |
| GCN | 38.1 ± 3.0 | 38.0 ± 4.5 | 40.2 ± 3.1 |
| | without class label induction | | |
| DW (LR) | 51.2 ± 3.1 | 54.1 ± 2.6 | 56.0 ± 1.5 |
| EP (LR) | 53.5 ± 2.7 | 55.7 ± 2.3 | 56.9 ± 1.1 |
| | with class label induction | | |
| S-DW (LR) | 50.9 ± 2.2 | 54.3 ± 1.9 | 56.5 ± 1.9 |
| S-EP (LR) | 53.5 ± 2.7 | 55.7 ± 3.3 | 58.2 ± 1.5 |
| | 20 Newsgroups | | |
| Pᵣ | 5 | 10 | 20 |
| FEAT (LR) | 69.1 ± 1.5 | 76.6 ± 1.1 | 82.5 ± 1.0 |
| LLE (LR) | 53.3 ± 1.2 | 59.0 ± 0.7 | 61.2 ± 0.6 |
| ISOMAP (LR) | 70.3 ± 1.2 | 73.2 ± 0.9 | 75.2 ± 1.0 |
| GCN | 73.8 ± 0.8 | 76.2 ± 1.1 | 77.2 ± 1.0 |
| | without class label induction | | |
| DW (LR) | 71.7 ± 1.0 | 72.9 ± 1.5 | 74.4 ± 1.2 |
| EP (LR) | 74.2 ± 1.3 | 77.5 ± 1.0 | 78.5 ± 0.9 |
| | with class label induction | | |
| S-DW (LR) | 71.5 ± 1.0 | 73.3 ± 1.4 | 75.6 ± 1.0 |
| S-EP (LR) | 76.9 ± 0.9 | 80.8 ± 1.2 | 83.3 ± 0.9 |
| | FMA | | |
| Pᵣ | 5 | 10 | 20 |
| FEAT (LR) | 39.8 ± 1.4 | 42.3 ± 0.5 | 43.5 ± 1.4 |
| LLE (LR) | 39.3 ± 1.4 | 40.4 ± 1.5 | 42.4 ± 1.0 |
| ISOMAP (LR) | 41.0 ± 1.3 | 42.1 ± 0.6 | 43.8 ± 1.1 |
| GCN | 17.6 ± 1.5 | 19.5 ± 3.3 | 26.0 ± 4.4 |
| | without class label induction | | |
| DW (LR) | 41.1 ± 1.3 | 42.8 ± 1.1 | 44.1 ± 0.8 |
| EP (LR) | 40.7 ± 1.3 | 43.0 ± 1.4 | 45.1 ± 0.9 |
| | with class label induction | | |
| S-DW (LR) | 40.6 ± 1.1 | 43.0 ± 1.5 | 44.9 ± 1.0 |
| S-EP (LR) | 40.5 ± 1.4 | 43.9 ± 1.2 | 46.6 ± 1.3 |

Table 5 below lists the performance of EP and the instance that incorporate sequence data, called EP-GRU, in FMA and FMA (Seq), respectively. EP-GRU is used on the sequence data, but a linear embedding function f is still used on the label type that corresponds to the node identifiers. To ensure a fair comparison, for all experiments the graph that was previously induced with the 140-dimensional vectors was used. As always, the same splits of training, validation and test are used for all experiments. EP-GRU leads to a consistent improvement over EP for all values of Pᵣ. It was also observed here that the induction of class label information is beneficial at least whenever the percentage of labelled data is over 5%.

TABLE 5

| Pᵣ | 5 | 10 | 20 |
|---|---|---|---|
| | FMA | | |
| EP (LR) | 40.7 ± 1.3 | 43.0 ± 1.4 | 45.1 ± 0.9 |
| S-EP (LR) | 40.5 ± 1.4 | 43.9 ± 1.2 | 46.6 ± 1.3 |
| | FMA (Seq) | | |
| EP-GRU (LR) | 43.0 ± 1.4 | 44.1 ± 1.4 | 46.4 ± 1.3 |
| S-EP-GRU (LR) | 42.7 ± 1.4 | 45.1 ± 1.3 | 47.9 ± 1.0 |

In summary, node representations learned independent of a specific classification function are especially advantageous as it allows to select the most accurate classification function for a given production system. As mentioned above, it has been shown that there is not any particular classification functions outperforming all others. Moreover, the classifier-agnostic representations have shown to significantly increase accuracy over unsupervised learning frameworks which do not use class label information.

FIG. 7 illustrates schematically illustrates a method and system for classifier-agnostic representation learning according to an embodiment of the present invention implemented in a personalization system 20 consisting of five main components: a data collection component 22, a node addition component 23, a classifier-agnostic representation learning component 25 and a classification functions component 24 for the personalization component 26. The system 20 and its components comprise one or more processors or servers having or having access to physical memory devices. The data collection component 22 specific to the embodiment shown in the medical domain collects K measurements (for example, biomarker data or X-ray) from the patient. The node addition component 23 is responsible for linking a new patient to the graph 21 based on a similarity measure between the new patient and previous ones, whose information is contained in electronic health records. The similarity between patients can be computed in different ways as a design choice. Therefore, a node of the graph 21 corresponds to a patient. Each node contains K measurements, and for some of them, the class label is known (in FIG. 7, the class labels indicate whether the patient needs treatment or not). The classifier-agnostic representation learning component 25 takes the graph of the previous component with their associated K label types and the set of class labels as input, and outputs classifier-agnostic representations for the nodes (patients), for example in accordance with Algorithm 1 (see FIG. 2). The classification functions are trained on the learned vector representations so as to achieve the best performance on some personalization task (e.g., personalized medicine). The classification functions component 24 takes the classifier-agnostic representations learned by the previous classifier-agnostic representation learning component 25 as input to one of the available classification functions, specifically, to the classification functions that achieved the best validation accuracy. The personalization component 26 maps the output of the previous classification functions component 24 to personalization actions. For example, it may suggest whether a treatment is needed for the patient or not based on the output of the previous classification functions component 24.

Other embodiments for different production systems or application settings, for example classification problems such as the news and music genre classification problems discussed above, hospital management, retail and recommender systems, telecommunications (e.g., user profiling), etc. can use analogous components to those shown in FIG. 7. The differences across embodiments mainly lie on: the set of K measurements collected by the data collection component 22; the similarity measure used to construct the graph 21 in the node addition component 23; and the mapping from the outputs of the classification functions component 24 to actual actions in the personalization component 26.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for learning classifier-agnostic node representations that are independent from particular classification functions and carry class label information, the method comprising:
learning representations of nodes of a graph structure according to an unsupervised learning framework by applying a distance-based or similarity-based loss between the nodes; and
learning embeddings of the class label information for at least some of the nodes; and
injecting the learned embeddings of the class label information into the node representations learned according to the unsupervised learning framework.

2. The method according to claim 1, wherein injecting the learned embeddings of the class label information further comprises:
maintaining a copy of class labels for each attribute label type of the nodes and, for each of the copies, learning a distinct embedding particular to the respective label types;
prior to each learning iteration, sampling for each of the nodes and each of the label types, a set of labels associated with the respective node for the respective label type uniformly at random, and choosing the label types for nodes not having class labels; and
using the sets of labels in a learning iteration according to the unsupervised learning framework.

3. The method according to claim 1, further comprising incorporating sequence data into the unsupervised learning framework.

4. The method according to claim 1, further comprising training a plurality of classification functions on the learned node representations, and selecting the classification function having the highest accuracy for a given production system.

5. The method according to claim 4, wherein at least one of the classification functions is non-differentiable.

6. The method according to claim 1, further comprising inducing the graph structure based on similarities among input samples.

7. The method according to claim 6, further comprising adding a new node to the graph structure based on similarities between the new node and the nodes of the graph structure.

8. The method according to claim 1, wherein the nodes correspond to patients and the node representations are learned according to the unsupervised learning framework based on similarities among the patients according to electronic health records, the method further comprising using one of a plurality of classification functions having a highest accuracy to determine a personalization action.

9. The method according to claim 8, wherein the personalization action is a decision to give medical treatment or no medical treatment.

10. A system for learning classifier-agnostic node representations that are independent from particular classification functions and carry class label information, the system comprising one or more processors which, alone or in combination, are configured to provide for execution of the following steps:
learning representations of nodes of a graph structure according to an unsupervised learning framework by applying a distance-based or similarity-based loss between the nodes; and
learning embeddings of the class label information for at least some of the nodes; and
injecting the learned embeddings of the class label information into the node representations learned according to the unsupervised learning framework.

11. The system according to claim 10, wherein injecting the learned embeddings of the class label information further comprises:
maintaining a copy of class labels for each attribute label type of the nodes and, for each of the copies, learning a distinct embedding particular to the respective label types;
prior to each learning iteration, sampling for each of the nodes and each of the label types, a set of labels associated with the respective node for the respective label type uniformly at random, and choosing the label types for nodes not having class labels; and
using the sets of labels in a learning iteration according to the unsupervised learning framework.

12. The system according to claim 10, being further configured to provide for the step of incorporating sequence data into the unsupervised learning framework.

13. The system according to claim 10, being further configured to provide for the steps of training a plurality of classification functions on the learned node representations, and selecting the classification function having the highest accuracy for a given production system.

14. The system according to claim 13, wherein at least one of the classification functions is non-differentiable.

15. A tangible, non-transitory computer-readable medium having instructions thereon, which, when executed by one or more processors, provides for execution of the following steps:
maintaining a copy of class labels for each attribute label type of the nodes and, for each of the copies, learning a distinct embedding particular to the respective label types;
prior to each learning iteration, sampling for each of the nodes and each of the label types, a set of labels associated with the respective node for the respective label type uniformly at random, and choosing the label types for nodes not having class labels; and
using the sets of labels in a learning iteration according to the unsupervised learning framework.
